(19) United States
(12) Patent Application Publication
(10) Pub. No.: US 2005/0288857 A1
(43) Pub. Date: Dec. 29, 2005

(54) Vehicle multimedia navigation apparatus with dual audio output

(75) Inventor: Stephen Chen, Shengang Shiang (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 10/873,155

(22) Filed: Jun. 23, 2004

(51) Int. Cl. G01C 21/26

(52) U.S. Cl. 701/211; 701/200

(57) ABSTRACT

A vehicle multimedia navigation apparatus with dual audio output has two sets of audio output channels or more. At least one set of the audio output channels is connected to an independent speaker set and one set or more is connected to an audio input device of a vehicle stereo which amplifies and broadcast through the vehicle stereo speaker set. Users can get navigation instructions from the independent speaker set or select the vehicle stereo to execute navigation or simultaneously broadcast multimedia audio.

### BACKGROUND OF THE INVENTION

1. Field of the Invention

The invention relates to a vehicle multimedia navigation apparatus with dual audio output and particularly to a vehicle multimedia navigation apparatus equipped with two sets of audio output channels or more so that in addition to an independent speaker to broadcast navigation instructions the vehicle stereo may also be chosen to execute navigation or concurrently broadcast multimedia sound.

2. Description of the Prior Art

A general vehicle navigation apparatus 1, referring to FIG. 1, has a navigation system architecture 10 which includes a satellite receiver 11, a control unit 12, a memory unit 13, a reading unit 14, a display device 15 and a speaker 16. The reading unit 14 reads data stored in storage media 17 (such as DVD, CD, MS, SM, MD, CF, SD, MMC and the like) to the memory unit 13, and the satellite receiver 11 receives satellite signals that are processed by the control unit 12 which outputs navigation data to the display device 15 and the speaker 16. A higher level vehicle navigation broadcast function usually has such speech navigation capability. Namely, before the vehicle arrives a crossroad, process is made according to the route and when turning is determined necessary, the speech navigation function will broadcast voice to remind the driver the turning instructions without the driver to see the navigation screen constantly. However, such a speech broadcasting vehicle navigation apparatus 1 has a big disadvantage in use. Namely, if the speech is broadcast through the vehicle stereo and the vehicle stereo is turned off or broadcasting of other audio programs is going on, the speech navigation cannot be performed. It is an issue users complain frequently. Another conventional technique is that the navigation system has its own speaker for broadcasting. But the speaker usually is inferior to that of the vehicle stereo. It even has only a mono-sound track. The result is not satisfactory.

### SUMMARY OF THE INVENTION

The primary object of the present invention is to provide a vehicle multimedia navigation apparatus with dual audio output that has an independent speaker to broadcast speech navigation instructions and also can select the vehicle stereo to provide navigation or simultaneously broadcast multimedia sound to solve the problems occurred to the conventional vehicle navigation apparatus.

In order to achieve the foregoing object, the vehicle multimedia navigation apparatus with dual audio output according to the present invention includes two sets of audio output channels or more. One set is connected to an independent speaker, and another set or more is connected to an audio input device of a vehicle stereo. Through amplifying by the vehicle stereo the speech is broadcast through the speaker of the vehicle stereo, thereby to overcome the problem of the conventional vehicle navigation apparatus that cannot select audio output as required.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a system block diagram of a conventional vehicle navigation apparatus.

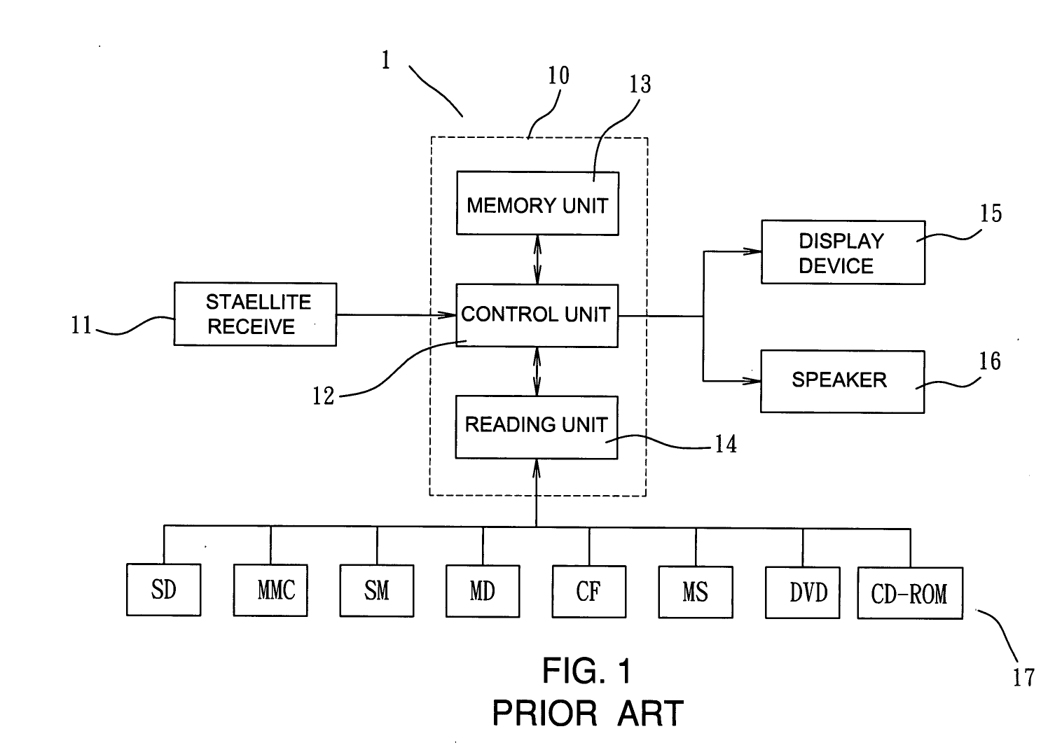

FIG. 2 is a system block diagram of a first embodiment of the invention.

FIG. 3 is a system block diagram of a second embodiment of the invention.

FIG. 4 is a system block diagram of a third embodiment of the invention.

FIG. 5 is a system block diagram of a fourth embodiment of the invention.

### DESCRIPTION OF THE PREFERRED EMBODIMENTS

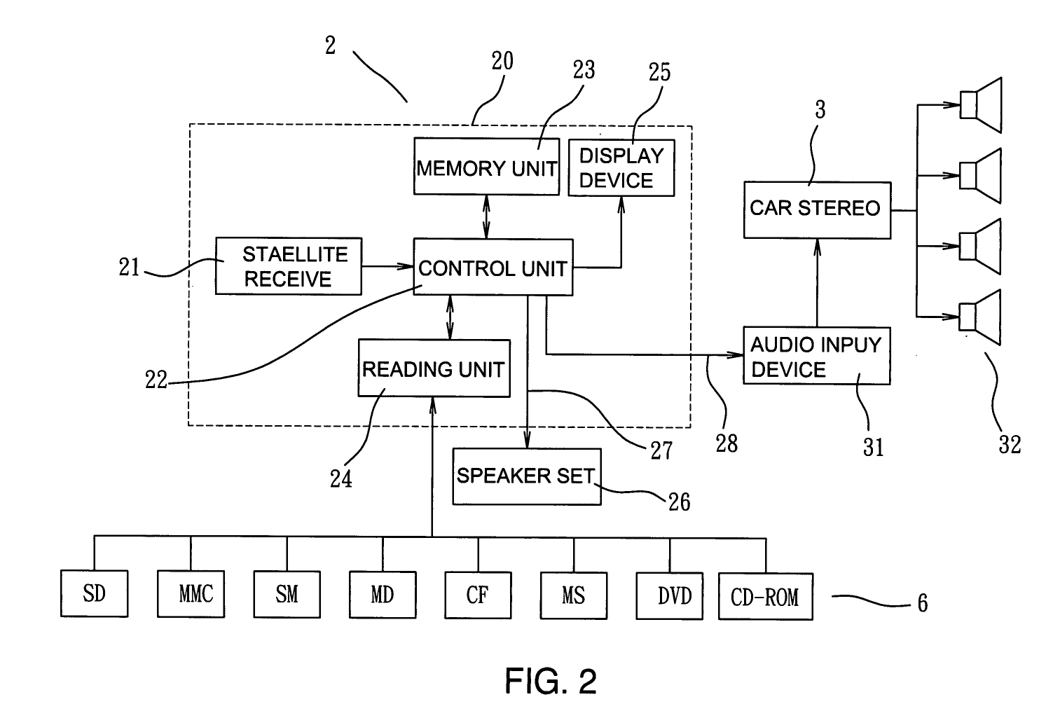

Refer to FIG. 2 for a first embodiment of the invention. The vehicle multimedia navigation apparatus with dual audio output 2 of the present invention mainly is under a navigation system architecture 20 and has two sets of audio output channels or more. The navigation system architecture 20 includes:
a satellite receiver 21 to receive satellite signals;
a control unit 22 to control operation of the navigation system and provide processing and execution of related software, such as navigation calculations, decoding of multimedia (MP3, DVD, VCD, and the like), switching of output mode, etc.;
a memory unit 23 to store data required by the control unit 22;
a reading unit 24 which is a reader to read information in a storage medium 6 (such as DVD, CD, MS, SM, MD, CF, SD. MMC, and the like);
a display device 25 to display information;
an independent speaker set 26 to provide audio output of the navigation system.

The invention has the following features:

Two audio output channels 27 and 28 are provided. One audio output channel 27 is connected to the independent speaker set 26, and another audio output channel 28 is connected to an audio input device 31 of a vehicle stereo 3. Hence audio output of the vehicle multimedia navigation apparatus 2 of the invention may be delivered through the independent speaker set 26, and also through a speaker set 32 of the vehicle stereo 3.

When the vehicle multimedia navigation apparatus 2 is performing navigation, if the vehicle stereo 3 is in the OFF condition, the audio output channels 27 is connected to the independent speaker set 26 to broadcast navigation instructions. The independent speaker set 26 may be located in the vehicle multimedia navigation apparatus 2 of the invention to simplify installation and save cost.

It is known that the speaker set 32 of the vehicle stereo 3 can broadcast best sound quality. Hence the vehicle multimedia navigation apparatus 2 of the invention also connects to the vehicle stereo 3 through another audio output channel 28 to broadcast music and entertainment programs.

Moreover, the audio output channel 28 linking to the vehicle stereo 3 may be accomplished by connecting an extension line to the audio input device 31 of the stereo 3. The audio input device 31 may be an audio input terminal.

In addition, due to the general vehicle navigation apparatus has excellent multimedia processing capability, and can rapidly process map moving, map turning, zooming and shrinking of satellite navigation, and also process sound and image compression and de-compression functions, such as MP3, MPEG-2 and MPEG-4 compression and playing, or even concurrently perform multiple functions, hence the vehicle multimedia navigation apparatus 2 may further be coupled with such vehicle navigation apparatus to acquire their original functions, and to couple with the vehicle stereo speakers that have better output sound quality, thereby to concurrently execute navigation and multimedia playing functions (such as MP3, CD, DVD, VDC, and the like). On the other hand, the reading unit 24 of the vehicle multimedia navigation apparatus 2 can read information stored in the storage media 6 (such as DVD, CD, MS, SM, MD, CF, SD, MMC and the like) into the memory unit 23 for the control unit 22 to process and output images to the display device 25 for displaying, while the audio signals are transferred through the audio output channel 28 and the audio input device 31 to the vehicle stereo 3, and be broadcast through the speaker set 32. In addition, the navigation instructions may be delivered through the audio output channel 27 to the independent speaker set 26. While the speech navigation instructions are broadcast, the control unit 22 controls the audio output channel 28 of the vehicle stereo 3 to reduce the sound volume or temporarily stop of the multimedia audio output to enable users to clearly hear the navigation instructions. Thus it can overcome the problems occurred to the conventional navigation apparatus that cannot output navigation instructions while broadcasting music.

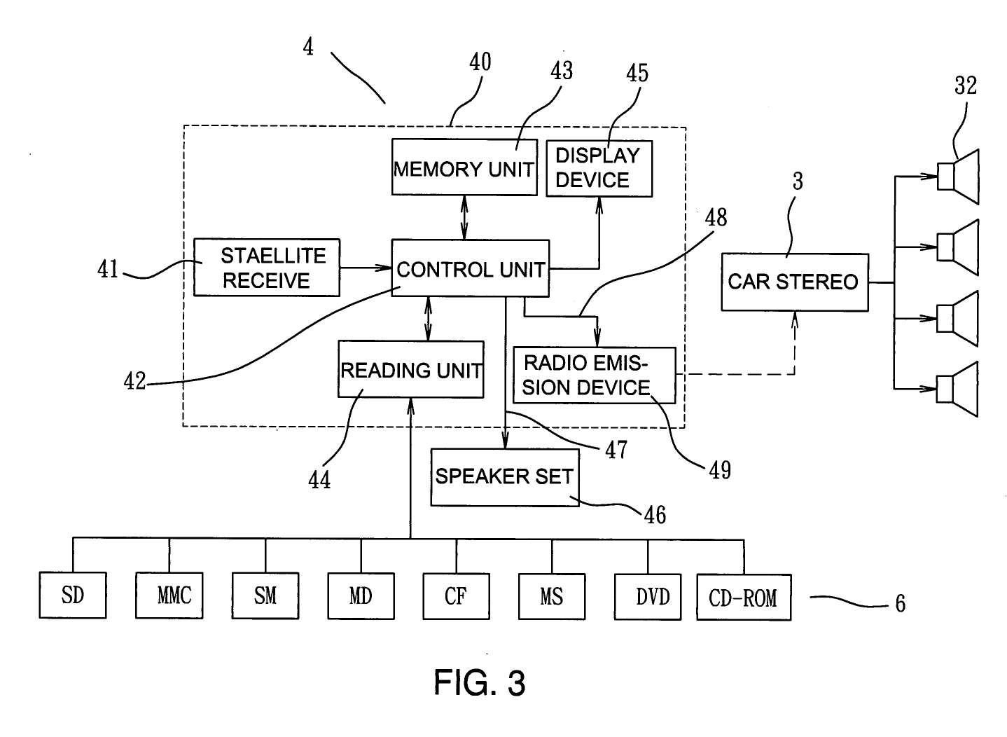

Refer to FIG. 3 for a second embodiment of the invention. The vehicle multimedia navigation apparatus 4 is an extension of the first embodiment under the basic architecture previously discussed. Namely under a navigation system architecture 40 two sets of audio output channels 47 and 48 or more are provided. The navigation system architecture 40 also includes a satellite receiver 41 a control unit 42, a memory unit 43, a reading unit 44, a display device 45 and an independent speaker set 46. The audio output channels 47 and 48 may be connected by physical lines or linked to a radio emission device 49. The radio emission device 49 receives audio signals transferred from the audio output channel 48 and modulates and transforms them to radio signals for emitting (the modulation may be radio signals such as FM, AM, infrared light, Bluetooth, and the like). Therefore when the vehicle multimedia navigation apparatus 4 outputs the audio signals through the audio output channel 48, the radio emission device 49 modulates the audio signals to radio signals (such as FM signals) for emitting, and the vehicle stereo 3 can receive the FM broadcast and output through the speaker set 32 of the vehicle stereo 3 for broadcasting. It can be installed wirelessly and conveniently.

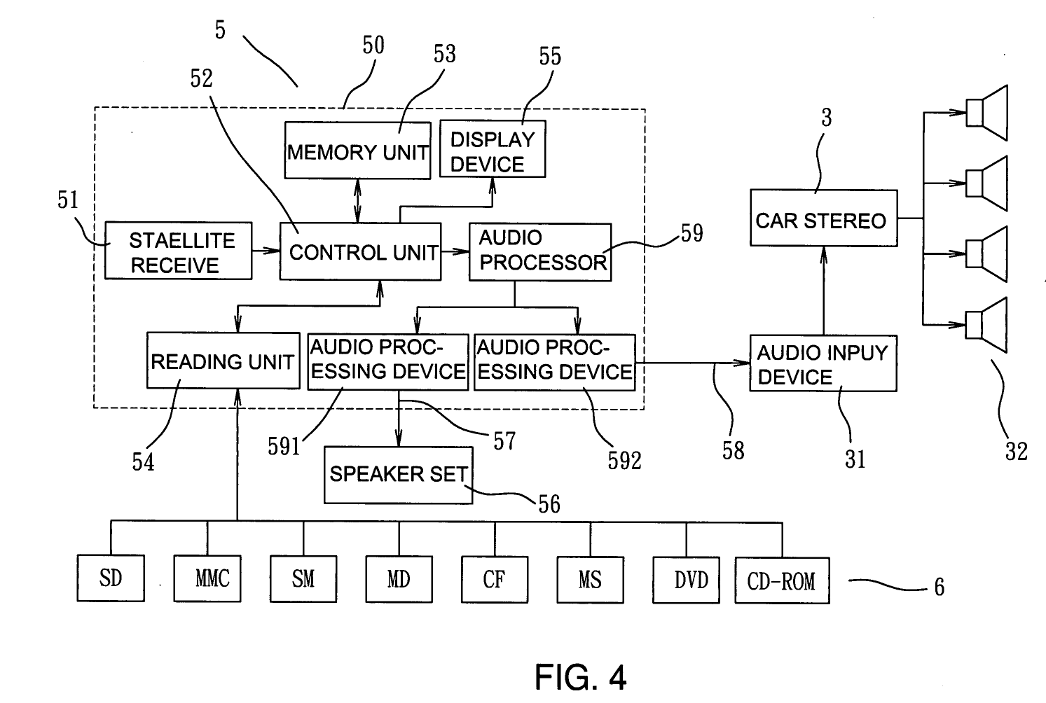

Refer to FIG. 4 for a third embodiment of the invention. The vehicle multimedia navigation apparatus 5 is an extension of the first embodiment under the basic architecture previously discussed. Namely under a navigation system architecture 50 two sets of audio output channels 57 and 58 or more are provided. The navigation system architecture 50 also includes a satellite receiver 51 a control unit 52, a memory unit 53, a reading unit 54, a display device 55 and an independent speaker 56. To meet the requirements of multimedia audio broadcasting (such as multiple sound tracks), an audio processor 59 and a plurality of audio processing devices 591 and 592 are added. The audio processing devices 591 and 592 have output ends connecting respectively to the audio output channels 57 and 58 in an one-on-one fashion to provide audio output through different audio output channels 57 and 58, such as output through the speaker set 32 of the vehicle stereo 3 or the independent speaker set 56.

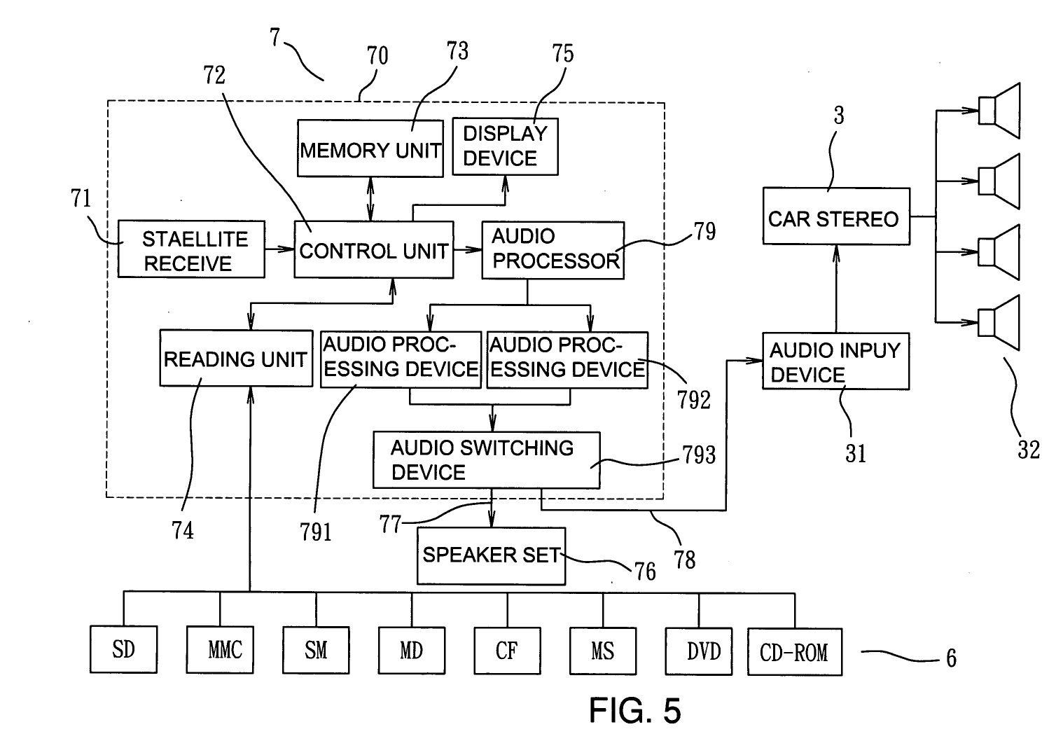

Refer to FIG. 5 for a fourth embodiment of the invention that is based on the third embodiment previously discussed. A vehicle multimedia navigation apparatus 7 is built under a navigation system architecture 70 which includes two sets of audio output channels 77 and 78 or more. The navigation system architecture 70 also includes a satellite receiver 71 a control unit 72, a memory unit 73, a reading unit 74, a display device 75, an independent speaker set 76, an audio processor 79 and a plurality of audio processing devices 791 and 792. The audio processing devices 791 and 792 are connected to an audio switching device 793 for switching control to different audio output channel 77 and 78, such as switching output through the speaker set 32 of the vehicle stereo 3 or the independent speaker set 76.

In summary, the invention provides multiple sets of audio output channels to overcome the disadvantages of the conventional vehicle navigation apparatus. Thus the invention has the following advantages:

1. In addition to an independent speaker set to broadcast navigation speech information, the invention also enables users to choose the speaker set of vehicle stereo to perform navigation, or simultaneously broadcast multimedia sound, thus resolves the shortcomings of the conventional vehicle navigation systems.

2. The invention provides more audio output modes.

3. The invention provides improved integration of the speaker sets of the vehicle navigation apparatus and vehicle stereo to achieve higher audio output quality and concurrently execute multiple functions.

4. The invention can provide radio transmission to reduce inconveniences of wiring and installation.

1. A vehicle multimedia navigation apparatus having dual audio output comprising two sets of audio output channels or more under a_navigation system architecture, wherein:
at least one set of the audio output channels is connected to an independent speaker set and another one set or more of the audio output channels is connected to a vehicle stereo which amplifies and broadcast through a vehicle stereo speaker set such that users are allowed to select the independent speaker set to broadcast navigation speech information or select the vehicle stereo to execute navigation or simultaneously broadcast multimedia audio.

2. The vehicle multimedia navigation apparatus of claim 1, wherein the another one set or more of the audio output channels is connected to an audio input device of the vehicle stereo to broadcast music through the vehicle stereo speaker set and output multimedia audio programs corresponding to the navigation system.

3. The vehicle multimedia navigation apparatus of claim 1, wherein the another one set of the audio output channels is connected to an audio input device through an extension line.

4. The vehicle multimedia navigation apparatus of claim 2, wherein the audio input device of the vehicle stereo is an audio input terminal.

5. The vehicle multimedia navigation apparatus of claim 1, wherein the audio output channels are connected to a radio emission device to modulate audio signals transferred from the audio output channels.

6. The vehicle multimedia navigation apparatus of claim 5, wherein the radio emission device modulates and emits frequency modulation (FM) signals.

7. The vehicle multimedia navigation apparatus of claim 5, wherein the radio emission device modulates and emits amplitude modulation (AM) signals.

8. The vehicle multimedia navigation apparatus of claim 5, wherein the radio emission device modulates and emits infrared signals.

9. The vehicle multimedia navigation apparatus of claim 5, wherein the radio emission device modulates and emits Bluetooth radio signals.

10. The vehicle multimedia navigation apparatus of claim 1, wherein the control unit controls output sound of the audio output channels at a reduced volume or to stop broadcasting temporarily.

11. The vehicle multimedia navigation apparatus of claim 1, wherein the control unit controls the multimedia audio and the navigation speech information to output through a same audio output channel.

12. The vehicle multimedia navigation apparatus of claim 1, wherein the navigation system architecture further includes an audio processor and a plurality of audio processing devices that have output ends connecting respectively to the audio output channels in an one-on-one fashion.

13. The vehicle multimedia navigation apparatus of claim 12, wherein the audio processing devices are connected to an audio switching device to switch control of the audio output channels.
